(19) United States
(12) Patent Application Publication
(10) Pub. No.: US 2009/0316006 A1
(43) Pub. Date: Dec. 24, 2009

(54) Camera and Method of Image Transmission by Local Network

(76) Inventors: Jean-Marie Vau, Paris (FR); Olivier A. Furon, Dinard (FR); Olivier L. Seignol, Grenoble (FR)

Correspondence Address: EASTMAN KODAK COMPANY;PATENT LEGAL STAFF, 343 STATE STREET, ROCHESTER, NY, 14650-2201, US

(21) Appl. No.: 11/795,728

(22) PCT Filed: Feb. 2, 2006
(86) PCT No.: PCT/EP06/00901

§ 371 Date: Sep. 4, 2009

(30) Foreign Application Priority Data
Feb. 9, 2005 (FR) 0501278

(51) Int. Cl. H04N 5/225

(52) U.S. Cl. 348/207.2

(57) ABSTRACT

The invention relates to digital equipment (10) capable of supplying image data comprising local wireless network communications (12) and a physical connection interface (14, 15, 18). According to the invention, the equipment also has means of detecting (16, 20) a mute connection of the interface (14, 18) to a connector (32, 38), the equipment being controlled by the detection means to automatically trip an image data transmission procedure from the camera to a printing station (30), through the local wireless network, in response to the detection of a mute connection. Application to mobile phones with image sensor or to any mobile terminal provided with multiple communications (wire and wireless).

### FIELD OF THE INVENTION

The present invention relates to a camera, and, more generally, to mobile equipment capable of supplying image data or multimedia data, having a physical connection interface and communications via a local wireless network. It also relates to a method of data transfer, and in particular image data, from the equipment to a printing station. The invention aims to offer wider compatibility between the equipment and printing stations not dedicated to this equipment. It has applications for general public cameras, such as digital cameras, digital video cameras or again mobile equipment such as telephones or organizers provided with an image sensor. The invention also has applications for mobile equipment which, while not having an image sensor, may store images temporarily, in order to transmit or reproduce them.

### BACKGROUND OF THE INVENTION

Mobile communication equipment enables the exchange of one and often several types of multimedia objects, such as text, sound, or images. For this purpose they are generally provided with several different communication devices, suited to various communication channels. Among the most wide-spread communication channels, there is Hertzian transmission by means of a distributed communications network, such as the telephone network, or transmission via the Internet. There is also transmission by local wireless network, which also takes place by Hertzian or by infrared means. Finally, some mobile equipment has a physical interface that enables data to be exchanged directly, by connecting the equipment to a data receiving device. The physical interface or a power supply interface can also be provided to connect the equipment with an electrical energy source to recharge its batteries.

Some manufacturers of digital cameras propose a printing station (dock) compatible with certain cameras of their range. Such is the case, for example, of printing stations commercially available under the Easyshare brand. The printing stations have an interface in the form of a connection base that can receive a physical connection interface of the compatible cameras. The stations also integrate a printer capable of producing proofs from image data transmitted by the camera connected with its interface on the base. The connection base of the printing station is similar to a USB (universal serial bus) port that, via a number of pins, enables digital data to be exchanged and received. The connection base also enables an electrical power current to be supplied or the batteries of the connected device to be charged. The printing station, like the camera and furthermore an increasing amount of multimedia equipment, can also be provided with local wireless network communications for exchanging data, for example with a home computer.

Finally, because of its size, generally larger than the mobile equipment for which it is designed, the printing station can have an ergonomic control interface, for example in the form of large buttons. The control interface then provides the user with facilities to control image transfer, processing or printing.

### SUMMARY OF THE INVENTION

The communication protocols used by cameras and compatible printing stations are mostly specific to each manufacturer. Practically, the user can only connect the compatible camera to their printing station. The compatibility relates both to the form of the interface connector and the base, and to the data exchange protocol. If, besides their compatible camera, the user of a printing station possesses another camera from another manufacturer, or a mobile phone provided with an image sensor, it will be impossible for them to benefit from the advantages of the printing station for this other non-compatible equipment.

The user may attempt to transfer the images through a local communications network if at the same time both their equipment and the printing station are provided with suitable communications and if it has sufficient controls to proceed with the transfer. Such a transfer is therefore cumbersome. Indeed, the incompatibility of the equipment will deprive the user of the facilities offered by the printing station and the connection base with which it is provided.

It is the object of the invention to remedy this difficulty by offering the possibility of automatically tripping an image data transfer from any multimedia equipment provided with wireless network communications to a printing station with which the equipment is not compatible, by simulating, for the user, the connection of compatible equipment.

In particular it is an object of the invention to enable a user of a printing station for cameras to use this station, with the same ease, to transfer and print images captured by other mobile equipment, such as a phonecam (phone with image sensor), for which the printing station was not originally designed.

To achieve these goals the invention has more precisely for object digital equipment capable of supplying image data, and in particular a camera, including local wireless network communications, and a physical connection interface. According to the invention, the equipment also has means to detect a mute connection of the interface to a connector, capable of being that of a printing station, the equipment being controlled by the detection means to automatically trip an image data transmission procedure from the equipment or camera to a printing station, through the local wireless network, in response to the detection of a mute connection.

Mute connection means any connection that does not enable the exchange of image data or any other multimedia object (image, video, sound or other content data). The impossibility of exchanging image data can result in particular from a physical, partial or total incompatibility of the connectors. The impossibility of exchanging image data can also result from the absence of a protocol or common exchange language between the printing station and the equipment connected to its connection base.

The mute connection used as trip, is preferably an electrical connection. However, it is possible to implement the invention simply with a magnetic or mechanical connection. The detection means of the equipment comprise, for example, an electrical switch capable of being actuated by the similarity of form between the printing station's connection base and a connector of the equipment's physical connection interface. The tripping of the switch in particular takes place when the equipment is installed on the base or a connector of the printing station in the same way as compatible equipment. The tripping is used as the detection signal of a mute connection.

The detected mute connection can also be an electric connection. For this purpose, the equipment can be provided with a detector of voltage or current charge, or a detector of the state of the physical connection interface. This is, for example, a USB (universal serial bus) type controller.

For example, a charge current detector can be planned on a recharging plug of the equipment3 s batteries. In this case, the charging, and in this case charging on a printing station, can be used as the tripping event of an image transfer process. For this form of equipment embodiment, one might worry that connecting the recharging plug to a simple electrical power supply could also trip, unnecessarily, the process of image data transmission. However, as a simple electrical power supply lacks any wireless network communications, any transmission attempt would inevitably be unproductive. The unwanted tripping would be ineffective and occur unnoticed. One development of the invention, described below, can also prevent, if necessary, any data transmission to a unwanted receiving device.

Although the invention in particular targets mobile equipment having an image sensor, such as a phonecam, the presence of an image sensor is not essential. The invention can be implemented for any equipment capable of supplying image data, such as an organizer, a pocket computer, or a backup equipment containing a memory.

The fact that the tripping of the procedure is automatic frees the image data transmission from any additional command of the user. The simple fact that the user connects their equipment to a printing station is interpreted as a command to transfer image data, thanks to the mute connection detection.

Thus there is no need for compatibility between the commands of the mobile equipment and those of the printing station. The transfer can take place without the user having to press a button.

“Printing station” means independent stations dedicated to a certain type of camera, as well as any computer equipment having a connector and provided with a printer. The fact that the printer is integrated into the station is an advantage but is not essential for implementing the invention.

To facilitate image transfer, the equipment can comprise, according to one development, a memory with programmed instructions intended for a s printing station, and capable of being transmitted in response to the detection of a mute connection. These are for example codes or instructions capable of being recognized by certain printing stations and which facilitate the transmission or enable layout or format selection commands to be made.

It is possible, as mentioned above, to benefit from all types of connector available on printing stations to make the mute connection. However, to favor the quality of the mute connection, at least mechanically, it is possible to provide the equipment with one or more removable adapters of shape compatible with printing stations.

Each adapter then has a first connector compatible with the physical connection interface of the equipment and a second connector compatible with the connection base of a given printing station.

The invention also relates to a method of data transfer from equipment capable of supplying image data and equipped with local wireless network communications and a physical connection interface. The method comprises:
the monitoring of the physical connection interface in order to detect a mute connection of the interface to a connector capable of being the connector of a printing station, and
the automatic tripping of an image data transmission process from the camera, through the local wireless network, in response to the detection of the mute connection.

The method can be implemented from the programmed instructions executed by the equipment, or possibly, by means of dedicated circuits.

As mentioned above, connection of the equipment to a simple electric power supply may, at least for certain embodiments of the invention, be interpreted as a mute connection. However, the tripping of a process of image data transmission then remains ineffective if no equipment provided with wireless network communications is available in the environment. It is nevertheless possible to plan an additional discriminatory measure to prevent data transmission to unwanted recipients.

Thus, the transmission method can include the search on the local wireless network for a transmitter-receiver being identified as a printing station, and, when a station is identified, sending the image data through the local network to the station.

The sending of the images can also be preceded by the search for at least one communication protocol in common with the station and the selection of the protocol for the image transmission. If several communication protocols are available, it is then possible to select the protocol having the best compatibility or having the best chances of sending the image data. For illustration, if at least two communication protocols for data transmission are found by the equipment, it can choose the one that offers most printing functions. For example, it is possible to choose a Bluetooth protocol enabling BPP (Bluetooth Printing Profile) rather than a simple infrared connection. Also, the equipment can take into account the type and/or data transfer speed of each protocol and choose the safest in terms of error checking and/or the one having the fastest transfer speed.

Finally, and as mentioned above, when a station is identified, the method can include sending to the station, through the local network, a program component comprising instructions for the transfer and/or processing of the image data.

In particular, it is possible to transmit instructions regarding the size of the required prints.

Other characteristics and advantages of the invention will appear in the following description, with reference to the figures of the appended drawings. This description is given purely as an illustration and is not limiting.

### BRIEF DESCRIPTION OF THE DRAWINGS

FIG. 1 is a schematic and simplified representation of equipment according to the invention and a printing station not dedicated to this equipment.

FIG. 2 is a flow chart showing the main steps of an image data transfer method according to the invention.

### DETAILED DESCRIPTION OF THE INVENTION

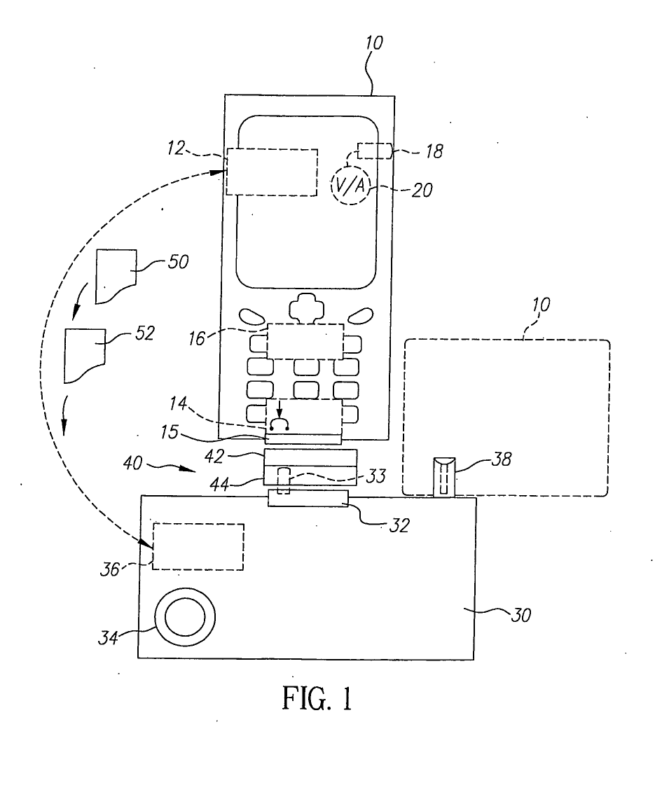

Reference 10 of FIG. 1 designates mobile equipment capable of supplying image data. In this case it is a mobile phone provided with an image sensor, also called “phonecam”. The equipment has a transmitter-receiver 12 capable of receiving and of transmitting data, and in particular image data on a local wireless communications network. Preferably, the transmitter-receiver is capable of exchanging data according to various communication protocols on local network such as Bluetooth, Wi-Fi, 3G or other.

The equipment 10 also comprises a connection interface 14 provided with a connector 15. The interface 14 is a communication interface similar to a USB interface (universal serial bus). It enables interoperability between the equipment 10 and other compatible equipment. The interface 14 is connected to an internal controller 16, also USB type, which controls the interface for exchanging data according to a protocol specific to the equipment's manufacturer. The controller 16 can also recognize certain states of the interface by detecting voltages on the terminals of the connector 15 (not shown). Among these states, for example, the following maybe identified: “not connected”, “connected, not powered”, “connected, powered, not configured” and “full connection”. The “full connection” state enables, if necessary, the transmission of image data through the connector 15 to a compatible printing station. The other connection states are mute connection states, which do not enable data exchange.

The connector 15 has a number of pins for data exchange, and possibly pins to receive a power supply current for charging the equipment's batteries. The batteries can also be charged by connecting a usual power supply plug into a socket 18 located at the top of the case of the equipment 10.

The reference 30 designates a printing station that is not compatible with the equipment 10. It has a connector in the form of a connection base 32 designed to receive the connector of the compatible equipment, not shown, so as to receive from this equipment image data, through the base. These data are then used to print images. The printing station also includes a control interface with ergonomic buttons 34, a transmitter-receiver 36 for communication by local wireless network, and, additionally, a plug 38 capable of delivering a power supply to an external device. The printing station, which is not a part of the invention, is described here briefly, simply to illustrate the possible interactions with non-compatible equipment for which it was not initially designed.

The reference 40 designates a removable adapter, capable of being attached to the connector 15. The adapter has a first connector 42 capable of being connected to the connector 15 of the equipment 10 and a second connector 44 capable of being connected to the base 32 of the printing station 30. The adapter has for function of enabling mechanical and/or electrical compatibility between the base 32 of the printing station and the connector 15 of non-compatible equipment.

Despite the adapter 40, the connection made between the mobile equipment 10 and the printing station, when the user places the equipment on the base 32, stays a mute connection if the equipment is not compatible with the printing station. This is very likely, especially when the printing station 30 and the equipment 10 do not come from the same manufacturer.

The equipment 10 has means to detect the mute connection. For example, this is the interface 14 in combination with the controller 16. Indeed, the controller can detect one of the above-mentioned states “connected, not powered” or “connected, powered, not configured”. The detection means can also comprise a simple switch of the interface 14, actuated mechanically and by shape similarity between the connector 15 and the base of the printing station. For illustration, FIG. 1 shows a pin 33 of the printing station capable of actuating a switch located in the equipment 10 or possibly in the adapter 40, when the equipment 10 is set up on the base 32 of the printing station.

The means for detecting a mute connection can also comprise a current or voltage detector 20 capable of measuring a current or charge voltage on a pin of the connector 15. The detector can be connected to the interface 14 or possibly to the above-mentioned socket 18. If this is the case, as the figure shows, a simple connection for battery charging, like that shown in broken line, makes the socket 18 and the plug 38 work together. This connection can then be detected as a mute connection. The plug 38 thus constitutes a connector of the printing station, in the same way as the base 32. Similarly, the socket 18 constitutes a physical connection interface within the meaning of the invention.

When a mute connection is detected, the equipment uses the local network communications to exchange data with the printing station. In particular, the equipment 10 can transfer image data 50 and possibly instructions in the form of software data 52 to the station 30.

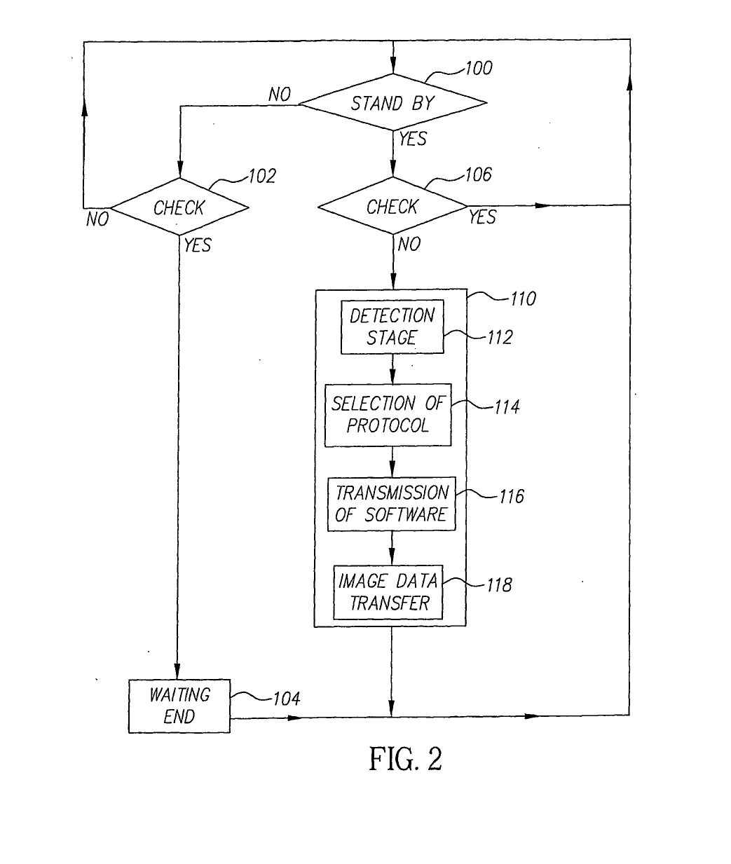

The data exchange is further described with reference to the flow chart of FIG. 2.

The monitoring of the physical connection interface of the mobile equipment awaiting a connection is shown on FIG. 2 by the reference 100. In the absence of a connection detection, a controller checks 102 whether a communication process is underway. If this is the case, the method continues by waiting 104 for the end of the communication process. Otherwise the controller returns the equipment to standby status to monitor the interface.

When a connection is detected, a check 106 also takes place to determine if a communication process is underway. If this is not the case, the communication process 110 is begun.

The communication process, actuated by the detection of a connection, has a first stage 112 of detection that consists in determining if there is a printing station in the equipment's local environment, and, if this is the case, which wireless communication protocols can be used to transmit data to this printing station. The detection step is not specific to the invention but usual for exchanges by local wireless network. For example, the standard Bluetooth protocol defines a search phase for equipment and thus the detection of a Bluetooth connection in the local environment of the transmitting equipment.

The detection step is directly followed by a selection 114 of the best exchange protocol when several protocols are possible. As described above, the selection criteria can be the transfer type and speed of each of the protocols. The number of functions offered by each protocol in terms of printing can also be taken into account. It should be noted that, in a particular implementation of the method, and where the detected connection is not mute, but would enable the direct exchange of data by the interface, the selection 114 could also relate to a direct exchange.

The selection of the protocol is followed by the possible transmission 116 of a software component, then by the transmission itself 118 of the image data, the transmission of the program component and the image data takes place through the local wireless network.

The program component can comprise a series of instructions capable of being executed by the printing station and aiming to increase its compatibility with the equipment to which it is connected. These are, for example, instructions for selecting the printing size or enabling the use of the control interface of the printing station.

However, the use of a control interface is not necessary insofar as the simple detection of a connection automatically trips the data transmission process.

Thanks to the step of checking 106, mentioned above, it is not necessary to keep the equipment on the printing station for the whole duration of the transmission or printing process. However, it is possible to connect the equipment several times to trip several transmissions and thus several printings of images.

1. Digital equipment (10) capable of supplying image or multimedia data, comprising local wireless network communication means (12) and a physical connection interface (14, 15, 18), characterized in that it also has means for detecting (16, 20) a mute connection of the interface (14, 18) to a connector (32, 38), possibly being a connector of a printing station, the equipment being controlled by the detection means to automatically trip an image data transmission procedure (110) from the digital equipment to a printing station (30) through the local wireless network, in response to the detection of a mute connection.

2. Equipment according to claim 1, wherein the means of detecting a mute connection has at least one from among a detector (20) of charge current, a detector of charge voltage, a detector of the state (16) of the physical connection interface and a switch capable of being actuated by shape similarity between a connector of a printing station and the connection interface (14, 15) of the digital equipment, when the equipment is set up on a printing station.

3. Equipment according to claim 1, wherein the physical connection interface (14) comprises at least one removable adapter (40).

4. An adapter (40) for equipment according to claim 1, comprising a first connector compatible with the physical connection interface (14, 15) of the equipment (10) and a second connector compatible with a connection base of a printing station.

5. A method of data transfer from an equipment (10) capable of supplying image data and equipped with local wireless network communication means and a physical connection interface, the method comprising:
the monitoring of the physical connection interface (14, 18) in order to detect a mute connection of the interface to a connector, possibly being the connector of a printing station, and
the automatic tripping of an image data transmission process (110) from the equipment to a printing station, through the local wireless network, in response to the detection of the mute connection.

6. A method according to claim 5, wherein the transmission process includes the search (112) on the local wireless network for a transmitter-receiver being identified as that of a printing station, and, when a such a transmitter-receiver is identified, sending (118) the image data through the local network to the printing station.

7. A method according to claim 6, also comprising the search (114) for at least one communication protocol in common with the printing station and the selection of the protocol for the image transmission.

8. A method according to claim 7 also comprising, when a printing station is identified, the sending (116) to the station, through the local network, of a program component including instructions for the transfer and/or processing of the image data.
